(19) United States
(12) Patent Application Publication
(10) Pub. No.: US 2014/0068277 A1
(43) Pub. Date: Mar. 6, 2014

(54) Secure Deletion of Data Stored in a Memory

(71) Applicant: Markus T. Metzger, Ulm (DE)

(72) Inventor: Markus T. Metzger, Ulm (DE)

(21) Appl. No.: 13/602,518

(22) Filed: Sep. 4, 2012

(51) Int. Cl. G06F 12/14; G06F 21/24

(52) U.S. Cl. 713/193

(57) ABSTRACT

In accordance with some embodiments, a granularity of memory such as block, may be deleted in a way to make it very difficult for an interloper to ever gain access to that block. Moreover the deletion may be done in a sufficiently efficient way and in a way that does not overly burden the user. In some embodiments, the encryption of the granularity of memory (such as a block) may be handled entirely within the memory. Then the encryption process cannot be accessed from the outside and the user need not be burdened with the sequence of encryption sequence since it is done automatically within the storage device.

### BACKGROUND

This relates generally to deleting data stored in electronic memories.

Conventionally, if a user attempts to delete data stored in a semiconductor memory, the data that the user thinks has been totally removed from the system is still present and can be extracted. This creates security concerns since confidential data may be available to an interloper who gains access to a user's computer either by obtaining the physical device or by accessing the device remotely.

One way to limit access to deleted data stored in a memory is to try to repeatedly overwrite the data. But this tends to be time consuming and may be error prone because the repeated writes may not totally overwrite the data, allowing some portions of the data to still be accessed.

Another approach is to encrypt each file in the memory and store an encryption key in another file. But this method is usually visible to the user and so places some overhead on the user. In addition, it may raise security concerns because the encryption key is stored in a file accessible to an attacker. Thus, from the user's point of view the deletion process requires the user's attention.

### BRIEF DESCRIPTION OF THE DRAWINGS

Some embodiments are described with respect to the following figures:

FIG. 1 is a schematic depiction of one embodiment of a platform according to the present invention;

FIG. 2 is a sequence for reading a block according to one embodiment of the present invention;

FIG. 3 is a sequence for writing a block according to one embodiment of the present invention;

FIG. 4 is a sequence for deleting a block according to one embodiment of the present invention;

FIG. 5 is a cross-sectional view of one embodiment of the present invention; and

FIG. 6 is a cross-sectional view taken generally along the line 6-6 in FIG. 5, according to one embodiment.

### DETAILED DESCRIPTION

As used herein, deletion refers to any action taken to limit access to stored information in the future.

In accordance with some embodiments, a granularity of memory such as block, may be deleted in a way to make it very difficult for an interloper to ever gain access to that block. Moreover the deletion may be done in a sufficiently efficient way and in a way that does not overly burden the user. In one embodiment, a block is the smallest addressable storage granularity. Other granularities larger than a block may also be used.

In some embodiments, the encryption of the granularity of memory (such as a block) may be handled entirely within the memory. Then the encryption process cannot be accessed from the outside and the user need not be burdened with the encryption sequence since it is done automatically within the storage device.

Among the types of storage devices that may be implemented according to embodiments of the present invention includes semiconductor, magnetic and optical memories. Generally, these memories include some type of onboard processing power that advantageously is not accessible from outside the memory. As a result, the encryption process and the process of deleting granularities of memory, such as a block, cannot be interfered with by outside software.

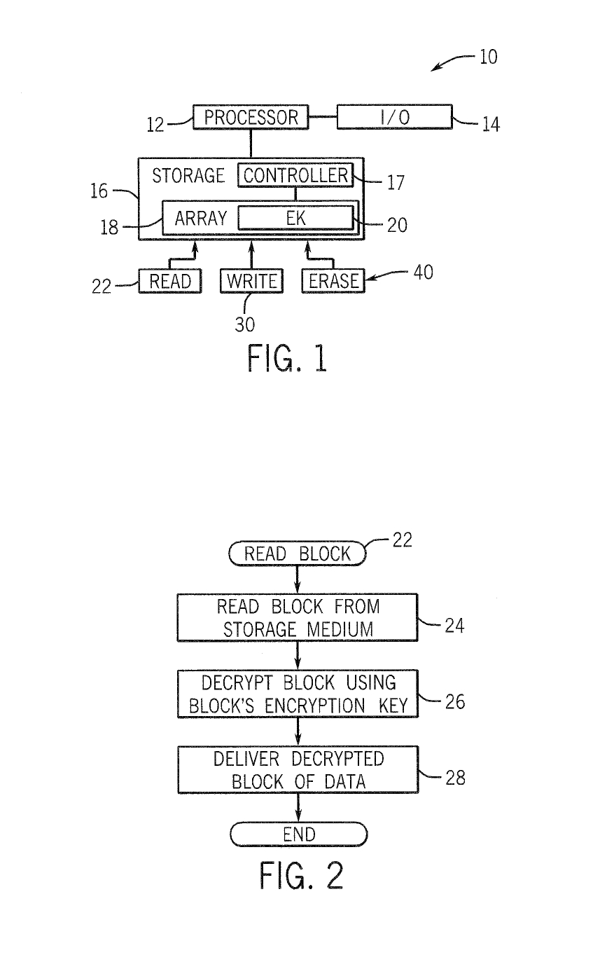

Thus referring to FIG. 1, a platform 10 may include one or more processors 12 coupled to input/output devices 14. Typical input/output devices include keyboards, printers, monitors or displays, mice, and touch screens to mention a few examples.

The processor may be coupled to a storage device 16 that may be any type of electronic storage. It may include a memory array 18 made up of rows and columns cells of any conventional or future memory technology. One area of that array, in one embodiment, may be used for storing an encryption key store 20. However, in other embodiments, the encryption key may be stored in a separate memory within the storage device 16.

The array 18 may be controlled by an onboard controller 17 which may be a processor-based device capable of executing instructions. It may implement the sequences for one or more of reading, writing and deleting a granularity of memory such as a block. Thus it may be capable of performing operations for deletion of a memory portion without interference by outside entities. The controller 17 may be an integrated circuit within a package enclosing an integrated amount for said memory array. In one embodiment the memory array and controller are formed on the same integrated circuit die.

In one embodiment, the controller may erase a portion of the array or the entire array by simply changing an encryption key that is used to encrypt the data in the target memory portion. Then even if the data is accessed by an interloper, it cannot be decrypted because the encryption key cannot be found. Moreover, when an interloper tries to access data, that data is decrypted with a wrong key. In this way, rather than actually physically removing the stored state from each memory cell, a portion of the memory can be erased as a whole by simply making the encryption key inaccessible and thereby preventing anyone from being able to read the information encoded therein.

A number of different sequences for reading, writing, and erasing, 22, 30 and 40 may be stored in the array. In other embodiments, the sequences may be implemented in hardware or firmware.

In some embodiments, the sequences may be implemented by computer executed instructions stored in one or more non-transitory computer readable media such as a magnetic, optical and/or semiconductor storage. The computer executed instructions in one embodiment may be implemented entirely by the controller 17 within the storage device 16, which controller may be largely or entirely inaccessible from outside the storage device 16.

The storage device 16 is typically organized in fixed size blocks. Software operates on one block at a time. Higher levels provide finer granularity.

An array of registers may be defined in the storage device, one for each block in the encryption key store 20, for example. The register for block N contains an encryption key used to encrypt block N. The key register is not accessible from outside of the storage device 16 in some embodiments. Instead the register is solely used by the storage device 16 to perform its operations.

The encryption process itself may be transparent to the user outside the storage device 16. The storage device 16 automatically encrypts and decrypts data using the block's encryption key. The encrypted data may only be seen when the storage device 16 is removed from the platform 10 and read by other means.

When software wants to delete a block or other granularity, a new encryption key is generated for that block, overriding the old key, in a register with an encryption key storage 20. In some embodiments the new key is generated by the controller 17.

While the stored data is still unmodified on the memory array 18, after it has been deleted, it comes worthless to any attacker since a unique key is necessary to decode the data that has been effectively destroyed or erased.

Any attempt to access the deleted data through the storage device 16 results in an automatic, futile decryption attempt, using the wrong encryption key, resulting in material which is undecipherable.

Since the register holding the key is not accessible from outside, no copies of it may exist in some embodiments. Since the data on the memory array 18 is automatically encrypted and decrypted in some embodiments, the original encrypted data is normally not visible outside the storage 16 except when the storage device 16 is physically removed.

When the storage device 16 is powered off, in one embodiment, it may simply lose all the data, guaranteeing the highest level of security. This may be useful in cases where the device is holding temporary data or the stored data is highly sensitive. Well known techniques may also be used to avoid intermittent loss of power in other embodiments.

According to another embodiment, a key array may be written to an internal persistent memory within the storage device 16. The key array may be used to encrypt the key using a predefined device specific key. When powered on, the storage device may re-encrypt the data, thereby rendering the copy of the key array in the internal persistent memory useless. In still another embodiment, other techniques may be used to securely delete the copy of the key array. In this case, the problem has been reduced from securely deleting an entire memory disc to securely deleting a comparatively small storage medium.

According to another embodiment, the key array may written to an external removable storage medium.

In one embodiment, the key array may be encrypted using a pre-defined device, specific key or using a user defined-key. This encryption allows the user to remove the key array from the storage device, rendering its content worthless to attackers. In some embodiments, neither the encryption key, nor its encrypted data are accessible to attackers remotely. An attempt to use the Linux dd command to circumvent the encryption, decrypts the deleted data using a wrong key, rendering the data useless to the attacker.

Referring to FIG. 2, in order to read a block or other granularity of memory, the sequence read block 22 may be implemented in software, firmware and/or hardware. In one embodiment it may be implemented by the controller 17. In software and firmware embodiments it may be implemented by computer executed instructions stored in one or more non-transitory computer readable media such as magnetic, semiconductor or optical storage.

Initially at block 24, a block of memory is read from the storage medium by the controller 17. Then, the controller 17 decrypts the block using the block's own encryption key as indicated in block 26. Finally, the controller 17 delivers the decrypted block of data 28 to the processor 12 (FIG. 1).

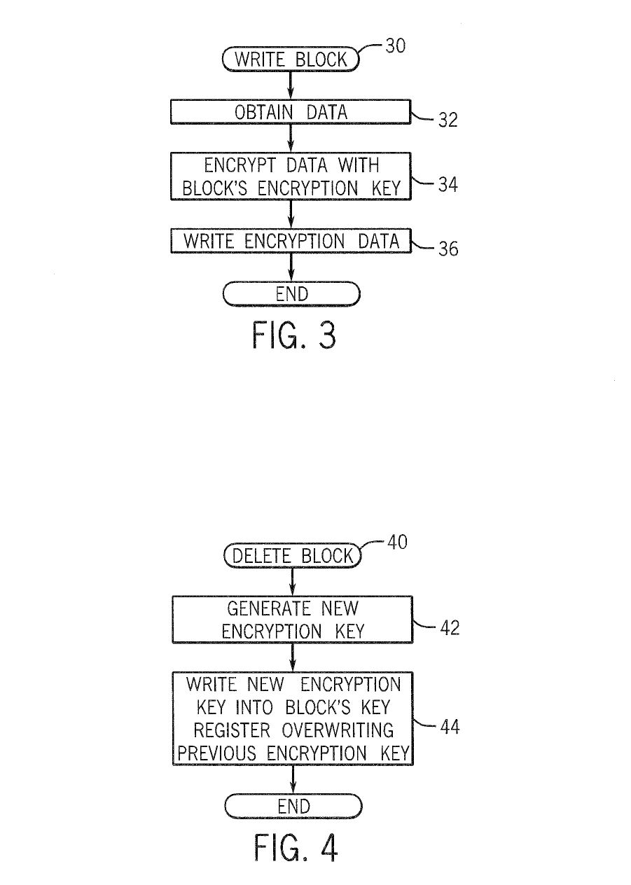

To write a block to the memory array, the sequence 30 in FIG. 3 may be used. The sequence 30 may be executed in firmware, hardware and/or software. In software and firmware embodiments it may be implemented by computer executed instructions stored in one or more non-transitory computer readable media such as magnetic, semiconductor or optical storage. In one embodiment it may be implemented by the controller 17.

Data to be written may be obtained, for example from the processor 12 as indicated in block 32. Then the data is encrypted by the controller 17 with the blocks encryption key as indicated in block 34. Therefore the encrypted data is actually stored in the array 18 by the controller 17 as indicated in block 36.

A delete block sequence 40, shown in FIG. 4 may be implemented in software, firmware and/or hardware. In software and firmware embodiments it may be implemented by computer executed instructions stored in one or more non-transitory computer readable media such as magnetic, optical or semiconductor storage. In one embodiment it may be implemented by the controller 17.

At block 42 the sequence begins by generating a new encryption key. Then the new encryption key is written into the block's key register, overriding the previous encryption key as indicated in block 44. This has the result of preventing access to the storage at least without removing the storage from the rest of the platform 10.

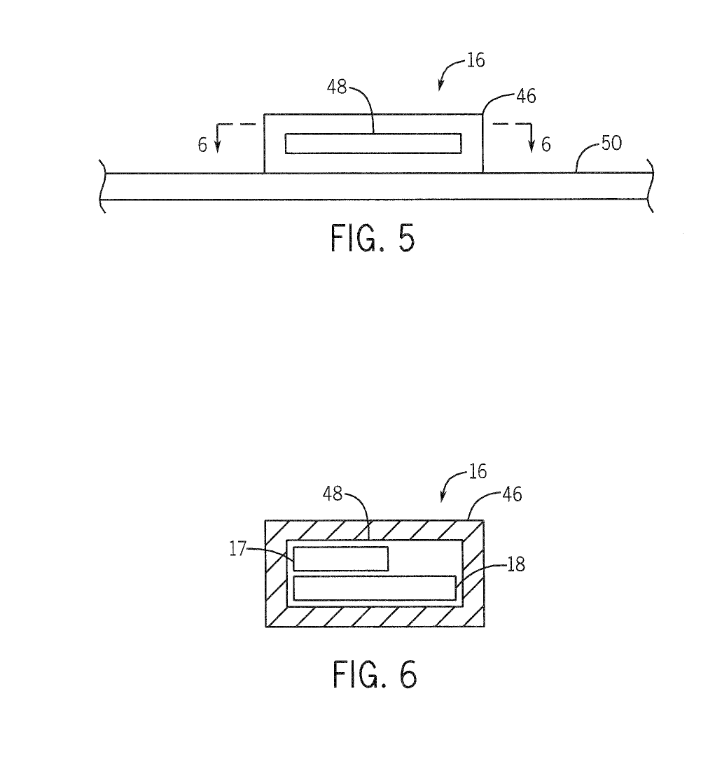

Referring to FIG. 5, the storage device 16 may be mounted on a circuit board 50. In some embodiments, the circuit board 50 may be used to implement a platform, such as a personal computer. But it could also be used in connection with a wide variety of processor-based devices, including laptop computers, cellular phones, mobile Internet devices, tablets, and desktop computers, to mention a few examples.

The circuit board 50 may be secured to the storage device 16 through its package 46 which may have appropriate interconnects, such as solder balls, pins, or the like (not shown). Inside the package 46, in one embodiment, may be a single integrated circuit 48. However, in other embodiments, more than one integrated circuit may be provided inside the package. For example, separate integrated circuits could be provided for the controller 17 and memory array 18, in some embodiments. In such case, the controller and memory array may be connected using interconnects, such as vias, wires, or other interconnection devices.

In some embodiments, as shown in FIG. 6, a single integrated circuit 48 may include a portion for the controller 17 and a portion for the memory array 18. Thus, in some embodiments, one single integrated circuit incorporates both the controller and the memory array. This may be economical and result in a relatively small footprint, in some embodiments.

The following clauses and/or examples pertain to further embodiments:

One example embodiment may be a method comprising encrypting data to be stored in a memory using an encryption key; and deleting a block of the memory by erasing the encryption key so that if the deleted block is accessed, it is automatically decrypted using a wrong encryption key. The method may include encrypting from within the memory. The method may include using a controller internal to said memory to delete the block. The method may include preventing external access to said controller. The method may include executing instructions for deleting said block within said memory. The method may include storing a plurality of blocks in the memory and storing encryption keys for each block within said memory. The method may also include using a controller within a package enclosing said memory to write and read from the memory. The method may include using a memory and controller integrated on the same die. The method may include making the encryption key inaccessible to a user. The method may also include making the encrypted data unreadable after deletion.

One example embodiment may be a non-transitory computer readable media storing instructions that cause a controller to perform a sequence comprising encrypting data to be stored in a memory using an encryption key, and deleting a unit of memory by erasing the encryption key so that if the deleted unit is accessed, a wrong encryption key is used to attempt decryption. The media may also include encrypting from within the memory. The media may also include using a controller internal to said memory to delete the unit. The media may also include preventing external access to said controller. The media may also include executing instructions for deleting said unit within said memory. The media may also include storing a plurality of memory units in the memory and storing encryption keys for each unit within said memory. The media may also include using a controller within a memory package to write and read from the memory.

Another example embodiment may be a memory comprising a memory array and a controller coupled to said array to encrypt data to be stored in the memory using an encryption key and deleting a block of memory by erasing the encryption key so that, if the deleted block is accessed, it is automatically decrypted using a wrong encryption key. The memory may also include said controller is within said memory. The memory may include said controller is within a package surrounding said memory array. The memory may include said controller to encrypt from within the memory. The memory may include said controller to prevent external access to said controller. The memory may include said controller to execute instructions for deleting said block within said memory. The memory may include a plurality of memory blocks and storing encryption keys for each block within said memory. The memory may include said controller and said memory array integrated in the same die.

One example embodiment may be a system comprising a processor and a memory coupled to said processor to encrypt data to be stored in the memory using an encryption key and deleting a block of memory by erasing the encryption key so that, if the deleted block is accessed, it is automatically decrypted using a wrong encryption key. The system may include said processor is within said memory. The said system may include said processor to encrypt from within the memory. The system may include said processor to prevent external access to said processor. The system may also include said processor to execute instructions for deleting said block within said memory.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
encrypting data to be stored in a memory using an encryption key; and
deleting a block of the memory by erasing the encryption key so that if the deleted block is accessed, it is automatically decrypted using a wrong encryption key.

2. The method of claim 1 including encrypting from within the memory.

3. The method of claim 2 including using a controller internal to said memory to delete the block.

4. The method of claim 3 including preventing external access to said controller.

5. The method of claim 4 including executing instructions for deleting said block within said memory.

6. The method claim 1 including storing a plurality of blocks in the memory and storing encryption keys for each block within said memory.

7. The method of claim 1 including using a controller within a package enclosing said memory to write and read from the memory.

8. The method of claim 3 including using a memory and controller integrated on the same die.

9. The method of claim 1 including making the encryption key inaccessible to a user.

10. The method of claim 1 including making the encrypted data unreadable after deletion.

11. One or more non-transitory computer readable media storing instructions that cause a controller to perform a sequence comprising:
encrypting data to be stored in a memory using an encryption key; and
deleting a unit of memory by erasing the encryption key so that if the deleted unit is accessed, a wrong encryption key is used to attempt decryption.

12. The media of claim 11, the sequence including encrypting from within the memory.

13. The media of claim 12, the sequence including using a controller internal to said memory to delete the unit.

14. The media of claim 13, the sequence including preventing external access to said controller.

15. The media of claim 14, the sequence including executing instructions for deleting said unit within said memory.

16. The media claim 11, the sequence including storing a plurality of memory units in the memory and storing encryption keys for each unit within said memory.

17. The media of claim 11, the sequence including using a controller within a memory package to write and read from the memory.

18. A memory comprising:
a memory array; and
a controller coupled to said array to encrypt data to be stored in the memory using an encryption key and deleting a block of memory by erasing the encryption key so that, if the deleted block is accessed, it is automatically decrypted using a wrong encryption key.

19. The memory of claim 18 wherein said controller is within said memory.

20. The memory of claim 19 wherein said controller is within a package surrounding said memory array.

21. The memory of claim 18, said controller to encrypt from within the memory.

22. The memory of claim 18, said controller to prevent external access to said controller.

23. The memory of claim 21, said controller to execute instructions for deleting said block within said memory.

24. The memory of claim 18, including a plurality of memory blocks and storing encryption keys for each block within said memory.

25. The memory of claim 18, said controller and said memory array integrated in the same die.

26. A system comprising:
a processor; and
a memory coupled to said processor to encrypt data to be stored in the memory using an encryption key and deleting a block of memory by erasing the encryption key so that, if the deleted block is accessed, it is automatically decrypted using a wrong encryption key.

27. The system of claim 26 wherein said processor is within said memory.

28. The system of claim 26, said processor to encrypt from within the memory.

29. The system of claim 26, said processor to prevent external access to said processor.

30. The system of claim 26, said processor to execute instructions for deleting said block within said memory.
